(19) United States
(12) Patent Application Publication
(10) Pub. No.: US 2010/0155199 A1
(43) Pub. Date: Jun. 24, 2010

(54) FLUORORESIN-COVERED ROLLER AND PRODUCTION METHOD THEREOF

(76) Inventors: Yoshitaka Ikeda, Osaka (JP); Daisuke Shoji, Osaka (JP); Kazuhiro Kizawa, Osaka (JP)

Correspondence Address: DRINKER BIDDLE & REATH (DC), 1500 K STREET, N.W., SUITE 1100, WASHINGTON, DC, 20005-1209, US

(21) Appl. No.: 12/595,135

(22) PCT Filed: Apr. 9, 2008
(86) PCT No.: PCT/JP2008/057028

§ 371 Date: Feb. 5, 2010

(30) Foreign Application Priority Data
Apr. 9, 2007 (JP) 2007-101418

(51) Int. Cl. B65G 39/10; B32B 37/14

(52) U.S. Cl. 198/843; 156/229

(57) ABSTRACT

A fluororesin-covered roller and a production method thereof. The fluororesin-covered roller has a laminar structure in which a rubber layer and a fluororesin layer are provided in this order on a roller base material. In the fluororesin-covered roller, the fluororesin layer is a covering layer formed of a fluororesin tube having a thickness of 10 μm or more and less than 20 μm.

### TECHNICAL FIELD

The present invention relates to a fluororesin-covered roller and a production method thereof, more specifically, to a fluororesin-covered roller having a laminar structure in which a rubber layer and a fluororesin layer are provided in this order on a roller base material and to a production method thereof. A fluororesin-covered roller of the present invention can be used as a functional member to be placed at various portions in an image-forming apparatus incorporating an electrophotographic method. A fluororesin-covered roller of the present invention is especially suitable as a fixing belt to be placed at a fixing unit of an image-forming apparatus incorporating an electrophotographic method.

In the present invention, the fluororesin-covered roller is not limited to a roller member in which the roller base material is formed of a hollow or solid cylindrical formed body. The types of the fluororesin-covered roller include a belt member in which the roller base material is formed of an endless-belt-type metal or heat-resistant-resin tube.

### BACKGROUND ART

An image-forming apparatus, such as an electrophotographic copier, facsimile, and laser beam printer, generally forms an image through the procedure including the following processes:
(a) a charging process that charges a photoconductive drum equally and uniformly,
(b) an exposure process that forms an electrostatic latent image on the photoconductive drum by performing image exposure,
(c) a development process that forms a toner image by causing a toner to adhere onto the electrostatic latent image,
(d) a transfer process that transfers the toner image on the photoconductive drum to an image-receiving material, such as a sheet of paper or synthetic resin,
(e) a fixing process that fixes the unfixed toner image on the image-receiving material, and
(f) a cleaning process that removes the remaining toner on the photoconductive drum.

The above-described processes use various belt or roller members, such as a charging belt or roller, a transferring belt or roller, a developing belt or roller, a fixing belt or roller, and a pressing belt or roller. These members are required to have various capabilities suitable for their purposes. Of these capabilities, a common capability required is to have excellent toner-releasing ability so that their surface can be free from toner adhesion and toner filming.

For example, the fixing process generally fixes the unfixed toner image on the image-receiving material by passing the image-receiving material carrying the unfixed toner image between the fixing belt or roller and the pressing belt or roller to press the image-receiving material and concurrently to heat it through a heating means provided at the inside of the fixing belt or roller.

Consequently, among the various members in the image-forming apparatus, the fixing belt or roller placed in the fixing unit is required to have the following capabilities:
(1) excellent toner-releasing ability of its surface so that it can prevent the adhering of the unfixed toner on the image-receiving material,
(2) excellent thermal conductivity so that the unfixed toner image can be efficiently fixed onto the image-receiving material, and
(3) excellent durability so that its stable capabilities can be utilized for a long time.

The published Japanese patent application Tokukaihei 11-336742 (Patent literature 1) has proposed a rotatable body in which a rubber layer and a fluororesin layer are formed in this order on a roller- or tube-shaped base body, in which the rubber layer is formed of two types of rubber layers having different hardness.

As the method for forming a fluororesin layer on a rubber layer, when a method is employed in which fluororesin paint is applied onto the rubber layer to bake it, the rubber layer is deteriorated at the time of the baking because the baking temperature of the fluororesin is high. To solve this problem, the production method stated in Patent literature 1 employs the following method. First, fluororesin paint is applied onto the inner surface of a hollow cylindrical mold to bake it. Next, a film of a highly hard rubber material is formed on the surface of the fluororesin layer formed on the inner surface of the hollow cylindrical mold. Then, the vulcanization is performed to form a highly hard rubber layer. Subsequently, a base body is inserted into the hollow cylindrical mold so as to be placed at the center of the axis of the mold. A low-hardness rubber material is injected into the clearance between the base body and the highly hard rubber layer. Finally, the vulcanization is performed to form a low-hardness rubber layer.

The rotatable body disclosed in Patent literature 1 is excellent in toner-releasing ability, fixing ability, and durability. Nevertheless, the production method stated in Patent literature 1 has the following drawbacks:
(a) the operation is complicated,
(b) a costly mold is required, and
(c) when the mold is detached, the fluororesin layer having adhered to the inner surface of the hollow cylindrical mold is sometimes peeled.
   In addition, in the method in which the applied layer of the fluororesin is formed at the inner surface of the hollow cylindrical mold, it is difficult not only to form a fluororesin layer having a uniform thickness but also to achieve an extremely thin thickness of the fluororesin layer.

The published Japanese patent application Tokukai 2004-276290 (Patent literature 2) has proposed a production method of a fluororesin-covered roller. According to this method, first, a low-viscosity adhesive is applied onto the inner circumferential surface of a fluororesin tube having an inner diameter smaller than the outer diameter of the roller base material, or onto the outer circumferential surface of the roller base material, or onto both surfaces. Next, the roller base material is covered with the fluororesin tube while one end of the tube is being diametrically expanded. At this moment of the covering, the adhesive is used as a lubricant. According to the method stated in Patent literature 2, a relatively simple operation of the covering using the fluororesin tube can form at the outermost layer a fluororesin layer having excellent toner-releasing ability.

Patent literature 2 shows as an example of the material of the fluororesin tube a tetrafluoroethylene-perfluoroalkylvinylether copolymer (PFA). An embodiment of the literature uses a PFA tube. Patent literature 2 describes that it is desirable that the fluororesin tube have a thickness of 50 μm or less and that if the thickness is greater than this, its stiffness becomes high and the altering of the shape of the tube becomes difficult, making the insertion of the base material difficult. On the other hand, Patent literature 2 describes that it is desirable that the fluororesin tube have a thickness of 20 μm or more in terms of the formability and the performance at the time of the use as a roller. More specifically, the literature shows an embodiment in which a fluororesin-covered roller is produced by covering a rubber roller with a PFA tube having a thickness of 30 μm.

In recent years, in an image-forming apparatus incorporating an electrophotographic method, the market has been increasing the requirement of an increase in the speed of printing (printing and copying), the realization of a full-color image, and an increase in energy saving. To increase the speed of printing, it is necessary to increase the heating efficiency of the fixing unit to fix, at high speed, an unfixed toner image onto the image-receiving material.

For the formation of a full-color image, in the development process, developing operations are performed in succession by using color toners having individual colors such as cyan, magenta, and yellow, and in the transfer process, the color-toner images of individual colors are transferred onto the image-receiving material so as to be laminated successively. In the fixing process, it is necessary to fix the unfixed toner image thicker than a toner image of a single color onto the image-receiving material by heating and pressing the image to melt it sharply. To meet this requirement, it is necessary to increase the heating efficiency of the fixing unit.

In an image-forming apparatus, the fixing unit consumes a large amount of energy. Therefore, to increase the energy saving, it is desirable to employ a method that economizes the electric power necessary to heat the fixing unit and that increases the heating efficiency at the time of fixing. When the heating efficiency of the fixing unit can be increased, this increase entails the economization of the electric power.

As a method for increasing the heating efficiency of the fixing unit, there is a method that increases the thermal conductivity of the fixing belt or roller. Generally, in the fixing process, the unfixed toner image on the image-receiving material is fixed onto the image-receiving material by heating and pressing the image. In the conventional fixing unit, an image-receiving material carrying the unfixed toner image is passed between the fixing roller and the pressing roller, which are placed at the opposite position, to heat and press the unfixed toner image to fix it onto the image-receiving material. The fixing roller is equipped with a heating means such as an electric heater at its interior to control the surface temperature of the fixing roller. Therefore, to increase the heating efficiency at the time of development, it is desirable to increase the thermal conductivity of the fixing roller.

As a fixing method using a fixing belt, there is a method whose cross-sectional view is shown in FIG. 3. This method uses a fixing unit in which a heating means 32 is placed in the position opposite to a pressing roller 36 through a fixing belt 31 that holds the heating means 32 so as to enable it to rotate. When an image-receiving material 34 carrying an unfixed toner image 33 is passed between the fixing belt 31 and the pressing roller 36, the heat produced by the heating means 32 is applied to the unfixed toner image 33 through the fixing belt 31, which is relatively thin. Consequently, the fixing unit can start the operation only by requiring a short waiting time after the electric power is supplied. Thus, a fixed toner image 35 can be formed.

As the fixing belt, a structure is known in which a fluororesin layer is placed, through a rubber layer, on the surface of a base body formed of an endless-belt-type polyimide or metal tube. As the pressing roller, a roller is used in which a fluororesin layer is formed on a relatively thick rubber layer formed on the roller base material formed of a solid or hollow cylindrical core metal.

To reduce the size or weight of the fixing unit described above and to prevent the heat accumulation caused by the pressing roller, a fixing unit has also been developed that has a structure in which a bar-shaped pressing roller having a small diameter is placed, through the pressing belt, in the position opposite to a heating means at the inside of the fixing belt.

To increase the thermal conductivity of the fixing belt or roller, a method is considered effective in which the rubber layer contains a highly heat-conductive inorganic filler (hereinafter referred to as a “heat-conductive filler”). However, to secure the toner-releasing ability, when a fluororesin layer or a silicone-rubber layer is formed on the rubber layer, because of the significantly low thermal conductivity of these layers, it becomes difficult to sufficiently meet the high level of requirement for increasing the speed of printing, for example.

The fluororesin-covered roller specifically disclosed in Patent literature 2 has a covering layer that is formed of a fluororesin tube and that has a thickness as relatively thick as 30 μm. Consequently, even when the rubber layer contains a heat-conductive filler, it is difficult to sufficiently deal with the increase in the speed of printing.

When the rubber layer contains a large amount of heat-conductive filler, although the thermal conductivity of the rubber layer can be increased, its elasticity is decreased. To increase the thermal conductivity of the fixing belt or roller, when the intermediate rubber layer is omitted, the fixing belt or roller cannot fix the unfixed toner image on the image-receiving material such that the image is enwrapped. Consequently, the fixing ability of the toner becomes insufficient. In particular, the fixing ability of a thick full-color toner image is decreased.

Patent literature 1: the published Japanese patent application Tokukaihei 11-336742
Patent literature 2: the published Japanese patent application Tokukai 2004-276290

### DISCLOSURE OF THE INVENTION

### Problem to be Solved by the Invention

The problem of the present invention is to offer a fluororesin-covered roller in which a rubber layer and a fluororesin layer are formed in this order on a roller base material, wherein the outermost layer is formed by using a covering layer formed of an extremely thin fluororesin tube.

More specifically, the problem of the present invention is to offer a fluororesin-covered roller that has highly balanced coverability and durability and that can exercise excellent capabilities when placed as various belt or roller members in an image-forming apparatus incorporating an electrophotographic method.

In particular, the problem of the present invention is to offer a fluororesin-covered roller that is suitable to be incorporated into a fixing unit in an image-forming apparatus incorporating an electrophotographic method, that has excellent fixing ability in high-speed printing and full-color printing, and that is suitable as a fixing belt or roller having good durability.

The present inventors have intensely studied to solve the above-described problem and have conceived a method. According to this method, the fluororesin layer is provided by forming a covering layer formed of an extremely thin fluororesin tube, in a fluororesin-covered roller having a laminar structure in which a rubber layer and a fluororesin layer are provided in this order on a roller base material.

The present inventors have considered that in order to increase the thermal conductivity of the fixing belt or roller, it is effective to decrease the thickness of the fluororesin layer positioned at the outermost layer. In view of the workability, it is desirable to form a fluororesin layer by covering the rubber layer with a fluororesin tube. However, until now, it has been considered that the fluororesin tube is required to have a thickness of 20 μm or more as the production condition for the tube and as the operating condition for covering the rubber layer with the tube. In particular, it has been considered that it is extremely difficult to cover the rubber layer with an extremely thin fluororesin tube having a thickness of less than 20 μm without developing a tear or wrinkle. In addition, it has been anticipated that when the fluororesin tube is extremely thin, the durability and toner-releasing ability of the fluororesin-covered roller will be decreased.

On the other hand, the present inventors have found that even when the fluororesin tube has a thickness as extremely thin as less than 20 μm or even 18 μm or less, it is possible to produce a fluororesin tube having uniform thickness. The present inventors have found that even when an extremely thin fluororesin tube is used, it is possible to cover the rubber layer with the fluororesin tube without developing a tear or wrinkle in the tube by controlling both the relationship between the outer diameter of the rubber layer and the inner diameter of the fluororesin tube and various conditions such as the use of an adhesive at the time of the covering. In this case, as the fluororesin tube, an extremely thin fluororesin tube having an inner diameter smaller than the outer diameter of the rubber layer is used, and at the time of the covering operation, the tube is diametrically expanded so as to cover the rubber layer with intimate contact.

A fluororesin-covered roller of the present invention has not only excellent thermal conductivity and toner-releasing ability but also elasticity given by the rubber layer. Consequently, when the roller is incorporated as a fixing belt or roller into a fixing unit of a high-speed-printing-type image-forming apparatus (high-speed machine), it can achieve sufficient fixing ability. The above-described fixing belt or roller has an excellent fixing ability for a full-color toner image and a durability that stands comparison with the conventional product. The present invention has been completed based on these findings.

### Means to Solve the Problem

The present invention offers a fluororesin-covered roller that has a laminar structure in which a rubber layer and a fluororesin layer are provided in this order on a roller base material. In the roller, the fluororesin layer is a covering layer formed of a fluororesin tube having a thickness of 10 μm or more and less than 20 μm.

In addition, the present invention offers a method of producing a fluororesin-covered roller that has a laminar structure in which a rubber layer and a fluororesin layer are provided in this order on a roller base material. The method includes:

(1) a step 1 of forming the rubber layer on the roller base material,
(2) a step 2 of preparing a fluororesin tube having a thickness of 10 μm or more and less than 20 μm and having an inner diameter smaller than the outer diameter of the rubber layer,
(3) a step 3 of applying an adhesive onto the outer circumferential surface of the rubber layer, or the inner circumferential surface of the fluororesin tube, or both of these surfaces, and
(4) a step 4 of covering the rubber layer with the fluororesin tube while one end of the fluororesin tube is being diametrically expanded.

### EFFECT OF THE INVENTION

The present invention can offer a fluororesin-covered roller in which a rubber layer and a fluororesin layer are formed in this order on a roller base material, wherein the outermost layer is formed by using a covering layer formed of an extremely thin fluororesin tube.

A fluororesin-covered roller of the present invention has good covering ability and durability. When it is placed as a fixing belt or roller in a fixing unit of an image-forming apparatus incorporating an electrophotographic method, it can meet the requirement such as an increase in printing speed, a realization of full-color image, an increase in energy saving, and weight reduction. A fluororesin-covered roller of the present invention can be used not only as other various functional members of an image-forming apparatus but also as constitutional members of various apparatuses other than the image-forming apparatus.

### BRIEF DESCRIPTION OF THE DRAWING

FIG. 1 is a cross-sectional view of a fluororesin-covered roller of the present invention.

FIG. 2 is an illustration showing an example of a method of covering a rubber roller with a fluororesin tube.

FIG. 3 is a cross-sectional view of an example of a fixing unit using a fixing belt and a pressing roller.

### DESCRIPTION OF THE SIGN

1: Fluororesin-covered roller
2: Roller base material
3: Rubber layer
4: Adhesive layer
5: Covering layer formed of a fluororesin tube
21: Rubber roller
22: Roller base material
23: Rubber layer
24: Fluororesin tube
25: One end portion of a fluororesin tube
26: Chuck
31: Fixing belt
32: Heating means
33: Unfixed toner image
34: Image-receiving material
35: Fixed toner image
36: Pressing roller

### BEST MODE FOR CARRYING OUT THE INVENTION

The present invention allows, as the roller base material of a fluororesin-covered roller, the use of a hollow or solid cylindrical formed body or an endless-belt-type (also called a seamless-belt-type) metal or heat-resistant-resin tube.

Generally, the hollow or solid cylindrical formed body is a solid or hollow cylindrical formed body formed by using metal, which has good thermal conductivity, such as aluminum, aluminum alloy, iron, or stainless steel; ceramic material such as alumina or silicon carbide; or the like. The hollow or solid cylindrical formed body may have a hollow interior or a solid interior depending on the purpose of the fluororesin-covered roller. The hollow or solid cylindrical formed body may have the shape of a shaft provided with at its both ends a portion to be supported by a bearing. When the hollow or solid cylindrical formed body is made of metal, it is generally called a core metal.

A tubular base material such as a metal or heat-resistant-resin tube is a tube formed by using metal or heat-resistant resin and generally is an endless-belt-type formed body. The types of the material for the metal tube include iron, nickel, and alloy of these. When the electromagnetic induction heating system is employed for the heating of the fixing belt, it is desirable that the metal tube be made of iron, nickel, alloy of these, ferrite stainless steel, or the like. When the entire belt member is required to be heated efficiently as in the case of the fixing belt, it is desirable to use, as the metal tube, a nickel or stainless-steel belt, which has small thermal capacity, so that the belt is heated up more speedily by the electromagnetic induction heating.

As the material for the heat-resistant-resin tube, it is desirable to use a resin that has small thermal capacity so that it can raise its temperature speedily by the heating using a heater when the tube is used. Generally, a heat-resistant resin is used that has a heat-resistance-indicating temperature of 250° C. or more, the heat-resistance-indicating temperature including a melting point, heat deformation temperature, and thermal decomposition temperature.

The specific types of the heat-resistant resin include polyimide, polyamideimide, polyetheretherketon, polyphenylenesulfide, and polybenzimidazole. Of these, in terms of heat resistance and durability, it is desirable to use polyimide, polyamideimide, and polybenzimidazole, more desirably polyimide, particularly desirably thermosetting polyimide.

The thickness, diameter, length, and other dimensions of the roller base material are properly selected according to the purpose of the fluororesin-covered roller. For example, when the fluororesin-covered roller is used as the fixing belt or roller, the length of the base material is determined in accordance with the width of the image-receiving material. The diameter of the roller base material can be properly determined according to both the purpose of the fluororesin-covered roller and the type of image-forming apparatus. Nevertheless, in the case of a fixing belt or roller, in many cases, the diameter is selected usually in the range of 10 to 150 mm, desirably 13 to 100 mm, more desirably 15 to 40 mm. In the case of a fixing belt, the thickness of the roller base material is selected usually in the range of 20 to 100 μm, desirably 25 to 80 μm. The shape of the base material may be, in addition to the shape having a longitudinally uniform diameter, the shape of a crown, the shape of an inverted crown, a tapered shape, or the like.

In the case where the heat-resistant-resin tube is such a heat-resistant-resin tube as a thermosetting polyimide tube, it may contain an inorganic filler as required. The types of the inorganic filler include silica, alumina, silicon carbide, boron carbide, titanium carbide, tungsten carbide, silicon nitride, boron nitride, aluminum nitride, mica, potassium titanate, barium titanate, calcium carbonate, magnesium oxide, zirconium oxide, and talc. Of these, in terms of having a high thermal conductivity, it is desirable to use alumina, silicon carbide, boron carbide, and boron nitride.

When the heat-resistant-resin tube contains an inorganic filler, the employed content is usually 50 vol. % or less, in many cases 40 vol. % or less. The lowest value is 5 vol. % in many cases. To produce a thermosetting polyimide tube containing an inorganic filler, a polyimide precursor varnish containing a dispersed inorganic filler is used to form a coating on the surface of a solid or hollow cylindrical mold. Then, the heating is performed to transform the varnish into imide. Thus, the tube is formed.

The rubber layer is formed on the roller base material. It is desirable that the material for the rubber layer be heat-resistant rubber. The heat-resistant rubber is defined as a rubber that has a heat resistance for withstanding the continuous operation at a fixing temperature when the fluororesin-covered roller having a layer of the rubber is placed in a fixing unit. As the heat-resistant rubber, it is desirable to use silicone rubber or fluororubber. These heat-resistant rubbers may be used singly or in combination of two or more types. The rubber layer may be not only a single layer of silicone rubber or fluororubber but also a laminated layer of a silicone-rubber layer and a fluororubber layer, for example.

As the heat-resistant rubber, in terms of having excellent heat resistance, it is desirable to use milable or liquid silicone rubber, fluororubber, or a mixture of these. More specifically, the types of the heat-resistant rubber include silicone rubber, such as dimethyl silicone rubber, fluorosilicone rubber, methylphenyl silicone rubber, and vinyl silicone rubber; and fluororubber, such as vinylidene fluoride rubber, tetrafluoroethylene-propylene rubber, tetrafluoroethylene-perfluoromethylvinylether rubber, phosphazene-based fluororubber, and fluoropolyether. These rubbers may be used singly or in combination of two or more types. Silicone rubber and fluororubber may be used by blending them.

Of these, liquid silicone rubber and fluororubber are desirable because they facilitate the formation of a rubber layer having high thermal conductivity by containing a heat-conductive filler at high content. The types of the liquid silicone rubber include a condensation-type liquid silicone rubber and an addition-type liquid silicone rubber. Of these, an addition-type liquid silicone rubber is desirable.

The addition-type liquid silicone rubber is formed by using a mechanism in which polysiloxane having a vinyl group and polysiloxane having an Si—H bond are subjected to addition reaction using a platinum catalyst to crosslink siloxane chains. By changing the type or amount of the platinum catalyst or by using a reaction inhibitor (retarder), the curing speed can be changed without restraint. A room-temperature-curing type belongs to the two-constituent type and cures speedily at room temperature. A heat-curing type also belongs to the two-constituent type and is produced by adjusting the amount of the platinum catalyst or using a reaction inhibitor so that it can be heat-cured at a temperature of 100° C. to 200° C. A one-constituent heating type (hereinafter referred to as “one-constituent addition-type liquid silicone rubber”) is produced by intensifying the inhibiting action of the reaction inhibitor so that even when the two constituents are mixed as one-constituent type, it maintains a liquid state provided that it is held at low temperatures and transforms itself into a rubber state when cured by heating at the time of the use. Among these addition-type liquid silicone rubbers, it is desirable to use the one-constituent addition-type liquid silicone rubber in view of the easiness in the mixing operation with a heat-conductive filler and in the forming operation of a rubber layer, the interlayer adhering ability, and the like.

The rubber layer can have high thermal conductivity by containing a heat-conductive filler. When the fluororesin-covered roller is used as a fixing belt or roller placed in a fixing unit, the rubber layer usually has a thermal conductivity of 0.6 to 4.0 W/(m·K), desirably 0.9 to 3.0 W/(m·K), more desirably 1.0 to 2.5 W/(m·K). When the rubber layer is required to have particularly high thermal conductivity, it is desirable that the rubber layer have a thermal conductivity of 1.1 W/(m·K) or more, more desirably 1.2 W/(m·K) or more.

To increase the thermal conductivity of the rubber layer, it is desirable to employ a method that forms the rubber layer by using a rubber composite containing both at least one type of heat-resistant rubber selected from the group consisting of silicone rubber and fluororubber and a heat-conductive filler. If the rubber layer has excessively low thermal conductivity, when the fluororesin-covered roller is used as a fixing belt or roller, the heating efficiency decreases, making it difficult to sufficiently improve the fixing ability at the time of high-speed printing and full-color printing. If the rubber layer has excessively high thermal conductivity, because of the excessively high content of the heat-conductive filler, the mechanical strength and elasticity of the rubber layer may be decreased.

The types of the heat-conductive filler include electrically insulating inorganic fillers, such as silicon carbide (SiC), boron nitride (BN), alumina (Al₂O₃), aluminum nitride (AlN), potassium titanate, mica, silica, titanium oxide, talc, and calcium carbonate. These heat-conductive fillers may be used singly or in combination of two or more types. Of these, it is desirable to use silicon carbide, boron nitride, alumina, and aluminum nitride.

The heat-conductive filler usually has an average particle diameter of 0.5 to 15 μm, desirably 1 to 10 μm. The average particle diameter can be measured by using the “Shimadzu laser diffraction particle size distribution measurement device SALD-3000” made by Shimadzu Seisakusho, Ltd. If the heat-conductive filler has an excessively small average particle diameter, the effect of increasing the thermal conductivity tends to become insufficient. If the heat-conductive filler has an excessively large average particle diameter, the surface of the rubber layer develops unevenness, creating the possibility of decreasing the surface smoothness of the fluororesin layer on the rubber layer.

The content of the heat-conductive filler in the rubber composite is, with reference to the total amount of the composite, usually 5 to 60 vol. %, desirably 10 to 50 vol. %, more desirably 15 to 45 vol. %. If the content of the heat-conductive filler is excessively small, it becomes difficult to sufficiently increase the thermal conductivity of the rubber layer. If the content of the heat-conductive filler is excessively large, the mechanical strength and elasticity of the rubber layer shows a tendency of decrease.

Although the rubber composite containing the heat-conductive filler may be prepared by adding a heat-conductive filler to the rubber material, a commercially available product may also be used as required. An example of such a commercially available product is a one-constituent addition-type liquid silicone rubber containing a heat-conductive filler such as silicon carbide (SiC) (for example, X32-2020 made by Shin-Etsu Chemical Co.).

The thickness of the rubber layer may be determined properly according to the purpose and shape of the fluororesin-covered roller (a belt or roller member). More specifically, the thickness is usually 10 μm or more and 5 mm or less, desirably 50 μm or more and 3 mm or less. When the fluororesin-covered roller is a belt member whose base material is a metal or heat-resistant-resin tube, in consideration of the elasticity of the base material itself, it is desirable that the rubber layer have a thickness of 10 μm or more and 1 mm or less, more desirably 50 to 900 μm, particularly desirably 100 to 800 m. In many cases, the thickness of 200 to 350 μm can yield a satisfactory result. When the fluororesin-covered roller is a roller member whose base material is a hollow or solid cylindrical formed body, because the base material is hard, it is desirable that the rubber layer have a thickness of 50 μm or more and 5 mm or less, more desirably 900 μm or more and 3 mm or less.

When the fluororesin-covered roller is used as a fixing belt or roller, in order to give it elasticity, it is desirable that the rubber layer have low hardness. The hardness of the rubber layer can be defined as the hardness measured in accordance with the spring-type hardness test A type stipulated in the Japanese Industrial Standards JIS K 6301 (hereinafter referred to as “JIS-A hardness”). It is desirable that the rubber layer have a JIS-A hardness of less than 100, more desirably 20 to 90, yet more desirably 20 to 70, particularly desirably 20 to 60.

If the rubber layer has excessively thin thickness or excessively high hardness, the fixing belt or roller cannot melt the unfixed toner in such a way that the toner is enwrapped. Consequently, the fixing ability is decreased. In particular, when a color toner is used, defective fixing tends to occur. If the rubber layer has excessively thick thickness or excessively low hardness, this condition may create a problem in durability.

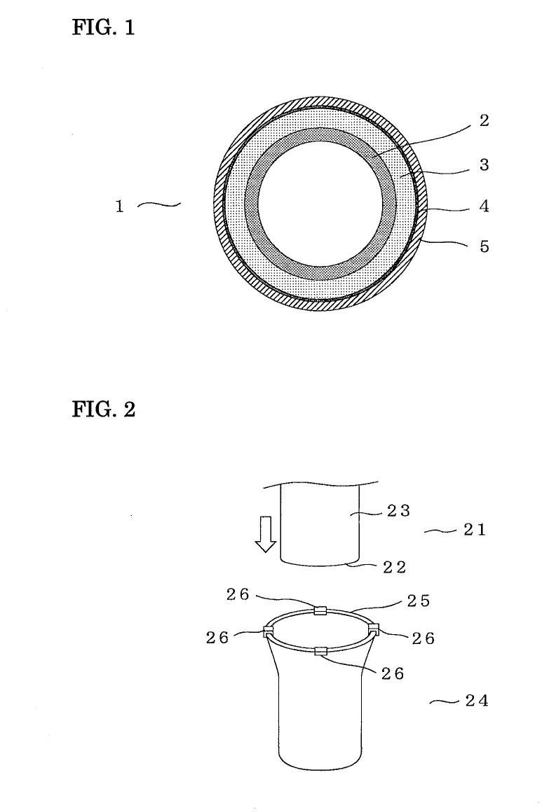

FIG. 1 shows a cross-sectional view of a fluororesin-covered roller 1 of the present invention. The roller 1 has a laminar structure in which a rubber layer 3 is formed on a roller base material 2 and as the outermost layer, a covering layer 5 formed of a fluororesin tube is formed. It is desirable to provide an adhesive layer 4 between the rubber layer 3 and the covering layer 5 formed of a fluororesin tube.

By placing a fluororesin layer at the outermost layer, the toner-releasing ability, heat resistance, and durability of the fluororesin-covered roller can be improved. When the fluororesin-covered roller is used as a fixing belt or roller, by placing the fluororesin layer at the outermost layer, the necessity of applying toner-releasing oil such as silicone oil can be eliminated or a sufficient toner-releasing ability can be achieved by applying a small amount of toner-releasing oil.

Generally, the fluororesin tube to be used in the present invention can be produced by extrusion molding. The types of material of the fluororesin tube include a tetrafluoroethylene-perfluoroalkylvinylether copolymer (PFA), a tetrafluoroethylene-hexafluoropropylene copolymer (PFP), polytetrafluoroethylene (PTFE), an ethylene-tetrafluoroethylene copolymer (ETFE), polychlorotrifluoroethylene (PCTFE), an ethylene-chlorotrifluoroethylene copolymer (ECTFE), and polyvinylidene fluoride (PVDF). Of these fluororesins, in terms of extrusion moldability, heat resistance, and toner-releasing ability, it is desirable to use a tetrafluoroethylene-perfluoroalkylvinylether copolymer (PFA).

The fluororesin tube has a thickness (average thickness) of 10 μm or more and less than 20 μm, desirably 12 to 19 μm, more desirably 13 to 18 μm. If the fluororesin tube has excessively thin thickness, this condition not only creates inferior extrusion moldability at the time of production but also tends to yield insufficiency of the workability of the covering operation onto the rubber layer, durability, and toner-releasing ability. If the fluororesin tube has excessively thick thickness, when the fluororesin-covered roller is used as a fixing belt or roller, the thermal conductivity becomes insufficient and the fixing ability is decreased in high-speed printing and full-color printing.

The fluororesin tube to be used in the present invention has a thickness of 10 μm or more and less than 20 μm and an inner diameter smaller than the outer diameter of the rubber layer. In other words, the rubber layer is formed so as to have an outer diameter smaller than the inner diameter of the fluororesin tube to be used. This fluororesin tube is not a heat-shrinkable tube.

The fluororesin-covered roller of the present invention is a fluororesin-covered roller having a laminar structure in which a rubber layer and a fluororesin layer are provided in this order on a roller base material, and the fluororesin layer is a covering layer formed of a fluororesin tube having a thickness of 10 μm or more and less than 20 μm. It is desirable that the fluororesin tube be a tetrafluoroethylene-perfluoroalkylvinylether copolymer (PFA) tube.

It is desirable that the rubber layer be covered with the fluororesin tube through an adhesive layer. It is desirable that the rubber layer be a heat-conductive rubber layer that is formed of a rubber composite containing both at least one type of heat-resistant rubber selected from the group consisting of silicone rubber and fluororubber and a heat-conductive filler and that has a thermal conductivity of 0.6 to 4.0 W/(m·K). A fluororesin-covered roller produced by using, as the roller base material, an endless-belt-type metal or heat-resistant-resin tube is suitable as a fixing belt or roller to be placed at a fixing unit of an image-forming apparatus incorporating an electrophotographic method.

A fluororesin-covered roller of the present invention can be produced by a production method including steps 1 to 4 described below:

(1) a step 1 of forming a rubber layer on a roller base material,
(2) a step 2 of preparing a fluororesin tube having a thickness of 10 μm or more and less than 20 μm and having an inner diameter smaller than the outer diameter of the rubber layer,
(3) a step 3 of applying an adhesive onto the outer circumferential surface of the rubber layer, or the inner circumferential surface of the fluororesin tube, or both of these surfaces, and
(4) a step 4 of covering the rubber layer with the fluororesin tube while one end of the fluororesin tube is being diametrically expanded.

In the step 1 described above, in terms of producing a fluororesin-covered roller having excellent thermal conductivity, it is desirable to form a heat-conductive rubber layer having a thermal conductivity of 0.6 to 4.0 W/(m·K) by using a rubber composite containing both at least one type of heat-resistant rubber selected from the group consisting of silicone rubber and fluororubber and a heat-conductive filler.

As the method of forming the rubber layer on the roller base material, it is desirable to use a press vulcanization method using a mold, or a method in which liquid rubber is supplied onto the roller base material using a dispenser to form a coating and then vulcanization is performed, or the like. When the roller base material is a metal or heat-resistant-resin tube, in order to employ the press vulcanization method, it is desirable to place the metal or heat-resistant-resin tube over a hollow or solid cylindrical supporter before performing the press vulcanization.

When the dispenser method is employed, the rubber layer is formed on the roller base material through the following steps:

(1) A step of forming a coating of liquid rubber in which liquid rubber is continuously supplied to the surface of the base material, while the base material is being rotated, using a dispenser equipped with a supplying section having a liquid delivery orifice at its end. At this moment, by moving the supplying section of the dispenser continuously along the axis of rotation of the base material, the liquid rubber supplied from the liquid delivery orifice is wound helically on the surface of the base material.
(2) A step of forming a rubber layer on the base material by curing (vulcanizing) the applied liquid rubber.
When measured at 25° C., the liquid rubber usually has a viscosity of 1 to 1,500 Pa·s, desirably 5 to 1,000 Pa·s. The liquid rubber may contain a heat-conductive filler.

As the method other than the above-described methods, for example, the rubber layer may be formed by placing the roller base material at the center of the axis in a hollow cylindrical mold and injecting a rubber material into the clearance between the inner surface of the hollow cylindrical mold and the outer circumferential surface of the roller base material. The vulcanization of the rubber layer may also be performed after the covering operation using the fluororesin tube. For example, when an adhesive layer is placed between the fluororesin tube and the rubber layer, the vulcanization of the rubber layer may be performed at the time of the curing of the adhesive layer.

It is desirable that the fluororesin tube to be prepared in the step 2 described above be a tetrafluoroethylene-perfluoroalkylvinylether copolymer (PFA) tube. The fluororesin tube to be used in the present invention has a thickness of 10 μm or more and less than 20 μm and an inner diameter smaller than the outer diameter of the rubber layer.

The fluororesin tube to be used in the present invention is not a heat-shrinkable tube. When a method is employed in which a heat-shrinkable fluororesin tube is placed over the rubber layer to be heat-shrank, the covering layer formed of an extremely thin fluororesin tube tends to develop a wrinkle. To prevent this defect, in the production method of the present invention, the fluororesin tube is placed over the rubber layer while the opening of one end of the fluororesin tube is being diametrically expanded.

A diameter difference, D, is calculated using the following equation:

D=[(d₁−d₂)/d₁)]×100,

where d₁ is the outer diameter of the rubber layer, and
d₂ is the inner diameter of the fluororesin tube.
   It is desirable that the fluororesin tube have a diameter difference, D, that satisfies the range of more than 0% and 10% or less, more desirably 1% to 8%, particularly desirably 2% to 5%. If the diameter difference D is excessively large, when the rubber layer is covered with the fluororesin tube, the tube tends to create plastic deformation. The plastic deformation reduces the workability of the covering operation and the durability and toner-releasing ability of the fluororesin-covered roller. If the diameter difference is excessively small, the degree of the intimate contact between the rubber layer and the fluororesin tube is decreased. When a roller base material on which a rubber layer is formed (hereinafter this roller base material is sometimes referred to as a “rubber roller”) has a diameter of, for example, 15 to 50 mm, it is desirable that the fluororesin tube have an inner diameter of 14 to 49 mm.

In the step 3 described above, it is desirable to use an adhesive that has a viscosity of 10 Pa·s or less when measured at 25° C. When an adhesive having low viscosity at the normal temperature is applied onto the outer circumferential surface of the rubber layer, or the inner circumferential surface of the fluororesin tube, or both of these surfaces, the adhesive acts as a lubricant at the time the rubber layer is covered with the fluororesin tube. Consequently, the covering operation can be performed smoothly. It is desirable that the adhesive have a viscosity of 7 Pa·s or less at 25° C. Its lower limit is 0.1 Pa·s or so. To adjust the viscosity of the adhesive, it may be diluted with a solvent as required. Nevertheless, providing that the coating of the adhesive does not adversely affect the workability of the covering operation using the fluororesin tube, its viscosity may lie at the outside of the above-described range.

As the adhesive, it is desirable to use an adhesive having excellent heat resistance, such as a silicone-based adhesive and an imide-based adhesive. Specific examples of the adhesive include GE Toshiba Silicones-made trade names TSE322, TSE3221, and TSE3221S and Shin-Etsu Chemical Co.-made trade names KE1825 and X32-1964. Nevertheless, the adhesive is not limited to these.

It is desirable that the inner circumferential surface of the fluororesin tube be surface-reformed through etching treatment, plasma treatment, or the like. Such a surface-reforming treatment can increase the adhering ability of the inner surface of the fluororesin tube with the adhesive, increasing the degree of intimate contact with the rubber layer. The surface reformation of the inner surface of the fluororesin tube can also be performed by ultraviolet irradiation, electron-beam irradiation, ion irradiation, laser irradiation, corona discharge, or the like.

In the step 4 described above, the rubber layer is covered with the fluororesin tube while the opening at one end of the fluororesin tube is being diametrically expanded. It is desirable that the expanding rate of the diameter of the fluororesin tube be, although depending on the value of the above-described diameter difference D, 1% to 15%, more desirably 2% to 10%. When an expanding rate of 3% to 8% or so is employed, a good result can be achieved.

The diameter expansion of the fluororesin tube can be performed through various methods, such as a method of performing the expansion at a time before the covering operation is performed onto the rubber layer, a method of expanding the diameter through the contact with the rubber layer at the time of the covering operation, a method of gradually expanding the diameter in which, first, the diameter is expanded to a certain extent before the covering operation onto the rubber layer and then the diameter is further expanded through the subsequent contact with the rubber layer, and the like.

An embodiment of the method of the covering operation using the fluororesin tube is explained below by referring to FIG. 2. As shown in FIG. 2, at the opening of one end of the fluororesin tube 24, four chucks 26 are attached to an opening end portion 25 such that the circumferential tensions become uniform. The other end of the fluororesin tube 24 is left free without constraint.

One end of a rubber roller 21 in which a rubber layer 23 is formed on a roller base material 22 is placed in the position opposite to the opening of the foregoing one end of the fluororesin tube 24. An adhesive is applied in advance onto the outer circumferential surface of the rubber layer, or the inner circumferential surface of the fluororesin tube, or both of these surfaces. The four chucks 26 attached to the opening end portion 25 of the fluororesin tube 24 are uniformly pulled so that their positions can be diametrically expanded. Without delay, the inner circumferential surface of the fluororesin tube 24 and the outer circumferential surface of the rubber layer 23 of the rubber roller 21 are brought into contact. While the diameter of the fluororesin tube 24 is being expanded, the rubber roller 21 is inserted into the fluororesin tube 24 from the one end of the tube.

In other words, in the step 4 described above, a plurality of chucks attached to one end of the fluororesin tube are pulled so that the opening at the one end of the fluororesin tube can be expanded. Next, the roller base material on which the rubber layer is formed is inserted into the opening of the fluororesin tube. This action bring into contact the inner circumferential surface of the fluororesin tube and the outer circumferential surface of the rubber layer. This contact expands the diameter of the fluororesin tube. While the diameter of the tube is being expanded, the rubber layer is covered with the fluororesin tube.

It is desirable that the rubber roller be inserted into the fluororesin tube at an insertion force of 1 to 20 kg, more desirably 2 to 10 kg. At the time of the covering operation, it is desirable that the rubber roller 21 be covered with the fluororesin tube in such a way that the excess-length portion of the fluororesin tube is placed at both axial sides of the rubber roller 21 and that subsequently, the excess-length portions be removed by cutting.

After the rubber layer is covered with the fluororesin tube under the condition of the normal temperature and atmospheric pressure with no pressure load, the adhesive is cured by the heating under the condition of 150° C. to 250° C. for 1 to 3 hours. When the rubber layer is in a state of unvulcanization, the vulcanization of the rubber layer may also be performed at the time the adhesive is cured. After the vulcanization treatment, the excess-length portion of the fluororesin tube at its both axial sides is cut so that the axial length of the fluororesin tube can become the same as the length of the rubber roller.

### Example

The present invention is more specifically explained below by describing Example and Comparative example. Nevertheless, the present invention is not limited to Example described below. The methods of evaluating the individual physical properties and characteristics are shown below.

### (1) Coverability

A roller base material on which a rubber layer was formed (a rubber roller) was covered with a PFA tube. At this moment, the coverability was evaluated by the following criteria:

A: the covering operation is performed smoothly and a covering layer having a uniform thickness can be formed,
B: the covering layer has poor surface appearance, and
C: it is difficult to form a covering layer having a uniform thickness.

### (2) Fixing Ability

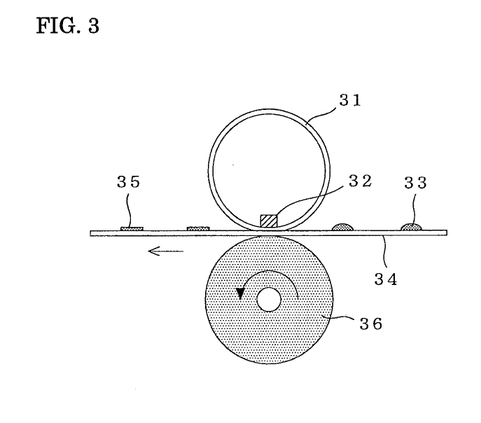

An individual fixing belt produced in Example and Comparative example was incorporated into a fixing unit of a commercially available electrophotographic copier. FIG. 3 shows a cross-sectional view of the fixing unit. The fixing unit has a structure in which a heating means 32 is placed in the position opposite to a pressing roller 36 through a fixing belt 31 that holds the heating means 32 so as to enable it to rotate. The pressing roller that is placed in the position opposite to the fixing belt has a structure in which a rubber layer and a fluororesin layer are formed in this order on a hollow cylindrical core metal. The fixing temperature was set such that the surface temperature of the fluororesin layer of the fixing belt became 190° C. The electrophotographic copier used was a high-speed machine whose printing rate was 30 sheets per minute. A black toner was used to form an unfixed toner image on a sheet of image-receiving paper. The sheet of paper was passed through the fixing unit to be heated and pressed to perform continuous printing of 50,000 sheets. To study the effect of the printing rate, a middle-speed machine whose printing rate was 15 sheets per minute was also used, and the result was evaluated similarly.

The fixing ability was evaluated by the following way. After the continuous printing of 50,000 sheets, a sheet of Silbon paper was placed on the fixed image formed on a sheet of image-receiving paper. A weight having a size of 5-cm square and a weight of 200 grams was placed on the sheet of Silbon paper to scrub it five times. Before and after the scrubbing, the fixed image was measured with a colorimeter to obtain the rate of decrease in the image density.

### (3) Durability

As described above, the individual fixing belt produced in Example and Comparative example was incorporated into a fixing unit of a commercially available electrophotographic copier. The fixing temperature was maintained at 190° C., and a black toner was used to perform continuous printing of 20,000 sheets at a printing rate of 30 sheets per minute. The durability of the fixing belt was evaluated by the following criteria:

A: the fixing belt shows no abnormality even after the continuous printing of 20,000 sheets,
B: an offset is produced or the sheet of image-receiving paper develops a wrinkle, and
C: the covering layer formed of a fluororesin tube in the fixing belt develops a split or tear.

### Example 1

On a stainless-steel tube having a thickness of 40 μm, a length of 240 mm, and an outer diameter of 23.7 mm, a rubber layer was formed by mold-pressing, at 170° C. for 30 minutes, a rubber composite, which contained silicone rubber (Dow Corning Toray-made Trade name SE6920) and alumina powder mixed with the rubber at a rate of 20 vol. %. The diameter of the rubber layer was adjusted to 24 mm by polishing the surface of the rubber layer. As the fluororesin tube, a PFA tube having a thickness of 15 μm and an inner diameter of 23 mm was prepared.

On the surface of the rubber layer, an adhesive was applied, which was prepared by diluting the adhesive TSE3221 (made by GE Toshiba Silicones) with a solvent (Shin-Etsu Chemical Co.-made diluent for silicone) and by adjusting the viscosity at 5 Pa·s when measured at 25° C. By the method shown in FIG. 2, four chucks were attached to one end portion of the PFA tube at equal circumferential spacings. One end of the rubber roller produced as described above was placed in the position opposite to the one end of the PFA tube. While the four chucks attached to the one end portion of the PFA tube were being diametrically expanded positionally, without delay, the inner circumferential surface of the PFA tube and the outer circumferential surface of the rubber roller were brought into contact, and the rubber roller was inserted into the PFA tube 24 from the one end of the tube. Subsequently, the adhesive was cured by the heating at 200° C. The excess-length portion of the PFA tube covering the rubber roller was cut to produce a fixing belt. The results are shown in Table I.

### Comparative Example 1

A fixing belt was produced by a method similar to the one used in Example 1, except that a PFA tube having a thickness of 30 μm was used in place of the PFA tube having a thickness of 15 μm. The results are shown in Table I.

TABLE I

| | | Comparative |
|---|---|---|
| | Example 1 | example 1 |
| Thickness of PFA tube (μm) | 15 | 30 |
| Coverability | A | A |
| Fixing ability | | |
| Image reduction rate (%) after continuous | | |
| printing of 50,000 sheets (fixing temperature: | | |
| 190° C.) | | |
| High-speed machine: 30 sheets/Min | 4 | 20 |
| Middle-speed machine: 15 sheets/Min | 1 | 2 |
| Durability | | |
| Continuous printing of 20,000 sheets | A | A |

As can be seen in the results shown in Table I, even when an extremely thin non-heat-shrinkable PFA tube having a thickness of 15 μm is used (Example 1), the workability of the covering operation is excellent and the durability is also good. Furthermore, the result shows that in comparison with the fixing belt covered with a PFA tube having a thickness of 30 μm (Comparative example 1), the fixing belt covered with a PFA tube having a thickness of 15 μm can sufficiently deals with the high-speed printing using a high-speed machine whose printing rate is 30 sheets per minute.

### INDUSTRIAL APPLICABILITY

A fluororesin-covered roller of the present invention having a covering layer formed of a fluororesin tube can be used, for example, as a fixing belt or roller in an image-forming apparatus incorporating an electrophotographic method. A fluororesin-covered roller of the present invention can also be used as various functional members of an image-forming apparatus that needs capabilities such as toner-releasing ability.

1. A fluororesin-covered roller, having a laminar structure in which a rubber layer and a fluororesin layer are provided in this order on a roller base material, wherein the fluororesin layer is a covering layer formed of a fluororesin tube having a thickness of 10 μm or more and less than 20 μm.

2. The fluororesin-covered roller as defined by claim 1, wherein the fluororesin layer is a covering layer formed of a fluororesin tube having a thickness of 13 to 18 μm.

3. The fluororesin-covered roller as defined by claim 1, wherein the fluororesin tube is a tetrafluoroethylene-perfluoroalkylvinylether copolymer (PFA) tube.

4. The fluororesin-covered roller as defined by claim 1, wherein the fluororesin tube is a non-heat-shrinkable PFA tube having a thickness of 13 to 18 μm.

5. The fluororesin-covered roller as defined by claim 1, wherein the rubber layer is covered with the fluororesin tube through an adhesive layer.

6. The fluororesin-covered roller as defined by claim 1, wherein the rubber layer is a heat-conductive rubber layer that is formed of a rubber composite containing both at least one type of heat-resistant rubber selected from the group consisting of silicone rubber and fluororubber and a heat-conductive filler and that has a thermal conductivity of 0.6 to 4.0 W/(m·K).

7. The fluororesin-covered roller as defined by claim 6, wherein the heat-conductive filler is at least one type of heat-conductive filler selected from the group consisting of silicon carbide, boron nitride, alumina, and aluminum nitride.

8. The fluororesin-covered roller as defined by claim 6, wherein the rubber composite is a one-constituent addition-type liquid silicone rubber containing silicon carbide.

9. The fluororesin-covered roller as defined by claim 1, wherein the roller base material is an endless-belt-type metal or heat-resistant-resin tube.

10. A method of producing a fluororesin-covered roller having a laminar structure in which a rubber layer and a fluororesin layer are provided in this order on a roller base material, the method comprising:
(1) a step 1 of forming the rubber layer on the roller base material;
(2) a step 2 of preparing a fluororesin tube having a thickness of 10 μm or more and less than 20 μm and having an inner diameter smaller than the outer diameter of the rubber layer;
(3) a step 3 of applying an adhesive onto the outer circumferential surface of the rubber layer, or the inner circumferential surface of the fluororesin tube, or both of these surfaces; and
(4) a step 4 of covering the rubber layer with the fluororesin tube while one end of the fluororesin tube is being diametrically expanded.

11. The method of producing a fluororesin-covered roller as defined by claim 10, wherein when a diameter difference, D, is calculated using an equation of
D=[(d₁−d₂)/d₁]×100,
where d₁ is the outer diameter of the rubber layer, and
d₂ is the inner diameter of the fluororesin tube,
the fluororesin tube has a diameter difference, D, that satisfies the range of more than 0% and 10% or less.

12. The method of producing a fluororesin-covered roller as defined by claim 10, wherein in the step 3, an adhesive is used that has a viscosity of 10 Pa·s or less when measured at 25° C.

13. The method of producing a fluororesin-covered roller as defined by claim 10, wherein the roller base material is an endless-belt-type metal or heat-resistant-resin tube.

14. The method of producing a fluororesin-covered roller as defined by claim 10, wherein the fluororesin tube has a thickness of 13 to 18 μm.

15. The method of producing a fluororesin-covered roller as defined by claim 10, wherein the fluororesin tube is a tetrafluoroethylene-perfluoroalkylvinylether copolymer (PFA) tube.

16. The method of producing a fluororesin-covered roller as defined by claim 10, wherein the fluororesin tube is a non-heat-shrinkable PFA tube having a thickness of 13 to 18 μm.

17. The method of producing a fluororesin-covered roller as defined by claim 10, wherein the rubber layer is a heat-conductive rubber layer that is formed of a rubber composite containing both at least one type of heat-resistant rubber selected from the group consisting of silicone rubber and fluororubber and a heat-conductive filler and that has a thermal conductivity of 0.6 to 4.0 W/(m·K).

18. The method of producing a fluororesin-covered roller as defined by claim 17, wherein the heat-conductive filler is at least one type of heat-conductive filler selected from the group consisting of silicon carbide, boron nitride, alumina, and aluminum nitride.

19. The method of producing a fluororesin-covered roller as defined by claim 17, wherein the rubber composite is a one-constituent addition-type liquid silicone rubber containing silicon carbide.

20. The method of producing a fluororesin-covered roller as defined by claim 10, wherein in the step 4, a plurality of chucks attached to one end of the fluororesin tube are pulled such that the opening at the one end of the fluororesin tube is expanded, and then the roller base material on which the rubber layer is formed is inserted into the opening of the fluororesin tube to bring into contact the inner circumferential surface of the fluororesin tube and the outer circumferential surface of the rubber layer and to cover the rubber layer with the fluororesin tube while the diameter of the fluororesin tube is being expanded through the above-described contact.
